(19) United States
(12) Patent Application Publication
(10) Pub. No.: US 2018/0061254 A1
(43) Pub. Date: Mar. 1, 2018

(54) Academic-Integrity-Preserving Continuous Assessment Technologies

(71) Applicant: Alexander Amigud, Toronto (CA)

(72) Inventor: Alexander Amigud, Toronto (CA)

(21) Appl. No.: 15/455,210

(22) Filed: Mar. 10, 2017

Related U.S. Application Data
(60) Provisional application No. 62/381,542, filed on Aug. 30, 2016.

(51) Int. Cl. G09B 5/00

(52) U.S. Cl. CPC G09B 5/00

(57) ABSTRACT

A system and method for maintaining academic integrity in the learning environment, based on behavioral pattern analysis of learner-produced content; wherein the behavioral patterns in learner-produced artifacts are compared to the known, previously acquired data and/or modeled behavioral data in order to continuously and/or on-demand estimate the probability of learner identity and the veracity of authorship of the academic work. The system and method optionally combines with mature and novel algorithms to perform content-level analyses such as plagiarism and collusion detection, authorship identification, and student profile-level analyses such as prediction of future performance.

### CROSS-REFERENCE TO RELATED APPLICATION

This application claims the benefit of U.S. Provisional Application Ser. No. 62/381,542, filed on 30 Aug. 2016.

### BACKGROUND OF THE INVENTION

The present invention relates generally to the area of teaching and learning. More particularly, the present invention relates to methods and/or systems for maintaining academic integrity of content-generating learning activities, and more particularly, the present invention relates to methods and/or systems for mapping learner identities with the academic work they do, by analyzing behavioral patterns in learner-produced artifacts. The continuously evolving landscape of academic and professional development programs poses a challenge to the integrity of performance assessment protocols. For instance, as physical entities become represented by virtual aliases, the class size increases, students are geographically dispersed, and the teaching and assessment roles become disaggregated, the complexity of maintaining academic integrity becomes significantly more difficult and resource-intensive.

Academic integrity is defined here as “the extent to which the assessment of student progress is carried out fairly, without bias, and without being compromised by dishonesty on the part of the test-taker in short, without cheating” (Shyles, 2002, p. 3). The assurance of identity and veracity of authorship is defined here as the confidence in knowing who the students are, and that the work they present, is actually the work they have done.

Academic integrity entails a need to establish a level of trust between learners and learning service providers. In the context of learning and teaching, establishing trust involves validating learner identity and veracity of authorship of the learner-produced work (Amigud, 2013). A test must be undertaken to determine if the trust relationship is indeed intact. This is accomplished by confirming that learners are who they say they are, and that they actually did the work they say they have done.

To date, there are several techniques that have been employed to validate identity and/or authorship claims. These include: (a) traditional proctoring; (b) audio-video monitoring; (c) biometric authentication; (d) authentication using challenge questions; (e) plagiarism detection tools; (f) monitoring and/or lockdown of learners' computing devices; (g) instructor and peer validation; (h) password authentication; and (i) verification of identity documents.

Some of the techniques are well-suited for verifying learner identities only (e.g., biometric authentication), while others validate only the authorship claims (e.g., plagiarism detection tools). The former is responsible for providing assurance in the identity of an entity, whereas the latter performs the evidence-gathering function. Once the identity has been successfully verified, the next step involves collecting evidence that could refute authorship claims. The integrity of the assessment activity is presumed to be sound unless there is evidence to the contrary.

Any combination of the identity and authorship validation techniques may be employed to establish a strategy for validating identity and/or authorship claims. However, the type and number of techniques any particular course or program employs, depends on the institutional context.

Strategies that validate both identity and authorship claims are often more logistically burdensome to manage, more expensive, and less accessible (Amigud, 2013). Due to their resource-intensiveness, they are employed selectively, targeting mainly high-stakes assessments, leaving low-stakes assessment activities vulnerable to academic misconduct.

The following examples demonstrate the traditional approach to provision of academic integrity in the traditional, blended and distance settings:

(a) In the traditional learning environment, much of the high-stakes assessments are proctored. Identity of a learner is generally validated by human invigilators, using officially-issued identification documents, that are compared against the physical appearance of the learner, whereas authorship is validated by the means of observation, in which absence of evidence of cheating is considered the evidence of true authorship;

(b) In the traditional setting, low-stakes assessments, such as weekly written assignments or participation in tutorials, may not undergo identity validation, whereas validation of authorship may be selectively performed by instructor or peers;

(c) When a learner participates in an online discussion forum, identity validation is generally performed through the learning management system's authentication component and validation of authorship is generally not performed due to a low-stakes nature of the activity;

(d) When a distance learner submits a written assignment, identity validation is again generally performed through the learning management system's authentication component. Validation of authorship may be performed by using a plagiarism detection tool that aims to refute authorship claim to the learner-produced academic artifact by locating similar content in a corpus of documents in the tool's database;

(e) When remote proctoring is employed, learner identities are generally validated using an image of officially issued documents transmitted via a video camera, compared against an image of the learner's physical appearance and/or biometric authentication using the proctoring service provider's authentication component. Authorship is validated through audio/visual monitoring and/or monitoring of the learner's computer, and/or lockdown of features of the learner's computer.

As can be seen from the examples above, the identity verification and authorship validation are two separate tasks conducted in a serial fashion, where identity verification precedes validation of authorship. Once the learner's identity is established, validation of authorship takes place. When technology is employed for identity verification, it follows an authentication/authorization scheme, where successful completion of identity verification enables the learner to access learning or assessment activities.

Furthermore, much of the approaches to validation of authorship use observation and environmental control. They do not examine authorship as a behavioral process, but rather attempt to detect any actions taken by students that may constitute a breach of academic conduct.

Some of the techniques require the acquisition of hardware (e.g., biometric scanners, web cameras). Some require the installation of software or granting personal computer access to a third-party to perform monitoring. Some approaches require the presence of human proctors and making advanced scheduling arrangements which in turn may affect accessibility and convenience of learning.

The present disclosure is intended to simplify and automate identity and authorship validation tasks, empowering faculty and administrative staff to have better control of the academic integrity aspects of the learning process and to promote accountability and the values of trust by mapping learner identities with the work they do.

### Enrollment

Learning begins with registration and enrollment, in which requirements vary by institutional context. Professional organizations, vocational schools, open educational resources and officially accredited colleges and universities require different levels of identity assurance and have different identity proofing procedures.

Identity enrollment may include taking a photograph and biometric signature of the student, followed by the issuing of identification tokens, such as a student number, student card and/or user credentials, to be used as a representation of physical identity for subsequent identity verification events.

When registering in credit-bearing studies (e.g., master's degree or electrician licensure), prospective learners are often required to provide personally identifiable information (identity proofing) such as government-issued IDs at the time of the application.

Academic partners such as proctoring or invigilation services may also collect personally identifiable information (e.g., official ID, and fingerprint scan) as a part of the registration process, independent of the information academic institution.

Much of the academic programs and courses have prerequisite requirements. Students are expected to demonstrate knowledge in the chosen discipline or demonstrate a certain level of performance. Learners need to provide evidence of meeting the program requirements to be accepted. For example, scores from the entrance exams, standardized test scores, academic records, samples of prior work, reference letters, transcripts, proof of language proficiency, and work experience may be used as admissions criteria. Once received, this information becomes a part of the student record and guides the admission decision. In spite of containing patterns of learner behavior, artifacts produced during or for the purposes of admissions are traditionally not used in assessment activities beyond the admissions process.

### Learner-Produced Content

Throughout the course of study, learners interact with the content, peers, and instructors (Moore & Kearsley, 1996). They participate in learning activities and demonstrate their understanding of the subject matter, level of competence, or skill by completing assignments, learning exercises, and assessments. For instance, students may be asked to participate in an online group discussion, write a research paper, solve a problem, answer questions, create a piece of visual art, write a computer program, or perform or compose a piece of music, just to name a few. A course is comprised of a number of learning activities that need to be successfully completed.

Through participation in these activities, learners produce academic work or artifacts. The learner-produced artifacts can be used to communicate learners' understanding of the topic at hand. They can also be used to evaluate learner performance, where learner-produced artifacts are qualitatively evaluated by an instructor or an assessor and a grade accompanied by feedback is provided.

A course credit or certificate of completion is issued to the learner when the learning provider or certification authority deems that course requirements are fulfilled by the learner in an honest fashion, in accordance with applicable policies and procedures.

### REFERENCES

Amigud, A. (2013). Institutional level identity control strategies in the distance education environment: A survey of administrative staff. The International Review of Research in Open and Distributed Learning, 14(5).

Moore, M. G., & Kearsley, G. (1996). Distance education: a systems view. Wadsworth Pub. Co.

Shyles, L. (2002). Authenticating, Identifying, and Monitoring Learners in the Virtual Classroom: Academic Integrity in Distance Learning.

### SUMMARY OF THE INVENTION

The present disclosure provides a system for maintaining academic integrity in the learning environment based on analysis of behavioral patterns in learner-produced artifacts comprising: a data management component for retrieving and processing data; a data analysis component for analyzing data; and a data storage component for storing raw and processed data; wherein the behavioral patterns in learner-produced artifacts are compared to the known, previously acquired data and/or modeled behavioral data in order to continuously and/or on-demand estimate the probability of learner identity and the veracity of authorship of the academic work.

The present disclosure also provides a method for maintaining academic integrity in the learning environment based on analysis of behavioral patterns in learner-produced artifacts comprising the steps of: acquiring learner behavioral data; and analyzing the acquired behavioral data; wherein behavioral patterns in learner-produced artifacts are compared to the known, previously acquired data and/or modeled behavioral data in order to continuously and/or on-demand estimate the probability of learner identity and the veracity of authorship of the academic work.

The present disclosure also provides a non-transitory computer-readable medium storing a set of programmable instructions configured for execution by at least one processor for maintaining academic integrity in the learning environment based on analysis of behavioral patterns in learner-produced artifacts, the method comprising the steps of: acquiring behavioral data; and analyzing the acquired behavioral data; wherein the behavioral patterns in learner-produced artifacts are compared to the known, previously acquired data and/or modeled behavioral data in order to continuously and/or on-demand estimate the probability of learner identity and the veracity of authorship of the academic work.

The method and system optionally combine with mature and novel algorithms to perform content-level analyses such as plagiarism and collusion detection, authorship identification, and student profile-level analyses such as prediction of future performance.

Aspects of the invention may comprise any method, system, device, apparatus, software, or firmware for mapping learner identities with academic work they do, through analysis of behavioral patterns in learner-produced artifacts.

In one embodiment, of the present invention, a system for maintaining academic integrity in the learning environment based on analysis of behavioral patterns in learner-produced artifacts is computer implemented and provides identity and authorship assurance of learning activities by performing analysis of behavioral patterns in the learner-produced artifacts, in order to map learner identities with academic work they do and/or report confidence level of each case of attribution and/or one of the following plagiarism, collusion, defined set of behaviors.

In one embodiment, of the present invention, a system for maintaining academic integrity in the learning environment based on analysis of behavioral patterns in learner-produced artifacts provides continuous and selective updating and reassessment of behavioral data extracted from learner-produced artifacts and/or performance assessment documents to be used in validation of identity and authorship of the learner-produced artifacts in a selective and/or cumulative fashion across learning activities, courses, programs or institutions.

In one embodiment, the type and format of the learner-produced content includes at least one of the following: textual content (e.g., research papers, computer source code, sheet music), visual content (e.g., paintings, drawings, computer graphics, photographs, videos), and aural content (eg, vocal recordings). Some artifacts are originally produced in digital format (e.g., online messages, emails, computer graphics), while others are produced using the traditional methods (paintings, hand-written sheet music). The latter needs to undergo digitization, if these type of artifacts were to be analyzed using the computer-assisted methods.

In one embodiment, a computer-implemented system for maintaining academic integrity in the learning environment, based on analysis of behavioral patterns in learner-produced artifacts provides academic quality control, by conducting a content-level analysis that identifies and reports learning activities that learners find challenging. For example, the analyses may include frequency and topics of social support inquiries, the relative frequency of plagiarism and collusion, and incongruence of the competence level of a student's profile and the learning activity.

In one embodiment, the computer-implemented system for maintaining academic integrity in the learning environment, based on analysis of behavioral patterns in learner-produced artifacts, identifies the need for academic support through the monitoring of learners' progress throughout the course of study.

In one embodiment of the present invention, the learner-produced content can be used selectively and/or cumulatively for validation of learner identity and veracity of authorship of learner-produced artifacts and/or for the prediction of certain behavior. Artifacts that are traditionally used for guiding admissions decisions, can be used in some or all performance assessment tasks.

These and other advantages, aspects and novel features of the present disclosure, as well as details of an illustrated embodiment thereof, will be more fully understood from the following description and drawings.

### BRIEF DESCRIPTION OF THE DRAWINGS

While certain embodiments depicted in the drawings, one skilled in the art will appreciate that the embodiments depicted are illustrative and that variations of those shown, as well as other embodiments described herein, may be envisioned and practiced within the scope of the present disclosure.

Various embodiments of the present disclosure will be described herein below with reference to the figures wherein:

FIG. 1a is a flow chart depicting a method for maintaining academic integrity in the learning environment based on analysis of behavioral patterns in learner-produced artifacts, in accordance with the present disclosure;

FIG. 1b is a flow chart depicting an academic process, in accordance with the present disclosure;

FIG. 1c is a diagram depicting a process for maintaining academic integrity in the learning environment based on analysis of behavioral patterns in learner-produced artifacts, in accordance with the present disclosure;

FIGS. 2a, 2b, 2c and 2d are block diagrams depicting a system for maintaining academic integrity in the learning environment, based on analysis of behavioral patterns in learner-produced artifacts, in accordance with the present disclosure;

FIG. 3 is a diagram depicting attribution of learner-produced artifacts, where an artifact whose authorship was claimed by Learner 1 is predicted to be of Learner 1 and an artifact claimed by Learner 2 is classified as one consistent with behavioral patterns exhibited by Learner 2.

FIG. 4 is a confusion matrix showing classification confidence scores, in accordance with the present disclosure;

FIG. 5 is a diagram depicting elements of the student profile, in accordance with the present disclosure;

FIG. 6 is a diagram depicting a computer-implemented system for maintaining academic integrity in the learning environment, based on analysis of behavioral patterns in learner-produced artifacts integrated with a learning management system, in accordance with the present disclosure;

FIG. 7 is a block diagram of a computer-implemented system for maintaining academic integrity in the learning environment, based on analysis of behavioral patterns in learner-produced artifacts.

### DETAILED DESCRIPTION OF THE INVENTION

In the following detailed description, numerous specific details are set forth to provide a full understanding of aspects and embodiments of the present disclosure. It will be apparent, however, to one ordinarily skilled in the art that aspects and embodiments of the present disclosure may be practiced without some of these specific details. In other instances, well-known methods and techniques have not been shown in detail to avoid obscuring the understanding of this description.

The present disclosure proposes a method and system as well as a non-transitory computer-readable medium storing a set of programmable instructions configured for execution by at least one processor for maintaining academic integrity in the learning environment based on analysis of behavioral patterns in learner-produced artifacts.

One purpose of the present disclosure is to map learner identities with academic work they do.

Another purpose of the present disclosure is to identify instances of academic misconduct.

Another purpose of the present disclosure is to provide academic quality control, by identifying tasks that learners find challenging.

Another purpose of the present disclosure is to assess the need for academic support through monitoring of learners' progress throughout the course of study.

The present disclosure proposes to solve one or more of the following problems:

(a) Given an artifact A, and a learner L who claims to have produced the artifact A, determine the degree of confidence that L has produced A;

(b) Given an artifact A, and an entity E who is either the learner in the course or an unknown party and does not claim to have produced the artifact A, determine the degree of confidence that E has contributed to the production of A;

(c) Given a presence of certain patterns or features in the learner profile comprised in-part of learner-produced artifacts and/or competence assessment results, predict learner behavior for event K.

In this disclosure, the terms “learner”, and “student” are used interchangeably to refer to an individual participating in learning activities.

In this disclosure, the terms “instructor”, “faculty”, “staff”, and “academic administrator” are used interchangeably to refer to any party representing the learning provider who manages the learning activities.

In this disclosure, the terms “content”, “academic content”, “artifact”, “academic artifact”, and “academic work” are used interchangeably to refer to any material produced by the learner.

Some aspects of this invention are based on the recognition of five concepts. First, the achievement of academic integrity is contingent on the successful mapping of learner identity with authorship of the learner-produced academic work. Second, production of any piece of academic work is a mental event whose parts have behavioral manifestations. Third, patterns comprised of certain behavioral characteristics, behavioral manifestations of mental events or processes are individually peculiar, and can be measured and analyzed. Fourth, artifacts produced by the same student are assumed to bear greater behavioral pattern similarity to each other, than to those of other students. Fifth, attribution or classification accuracy may not be established to a mathematical certainty, but to some degree of probability.

The novel approach includes, in part, continuous and selective updating and reassessment of behavioral data extracted from learner-produced artifacts and/or performance assessments to be used in validation of identity and authorship of subsequent artifacts in a selective and/or cumulative fashion across learning activities, courses, programs or institutions. The use of learner-produced content is no longer limited to select activities (e.g., admissions decision, course evaluation), but extends to any activity that requires identity and authorship assurance or may benefit from the use of extrapolated behavioral data.

The novel approach includes, in part, creating behavioral profiles from the artifacts created or provided during the registration, admission or enrollment phases and comparing them to behavioral patterns extracted from artifacts produced during subsequent learning activities; wherein a confidence factor of attribution of behavioral patterns in the learner-produced content is computed. For example, when a course or program has pre-requisite requirements such as an entrance examination or an assessment of previously conducted academic work such as a portfolio or a research paper, these learner-produced artifacts are collected and evaluated primarily for the purposes of admission. Artifacts or behavioral data contained within are traditionally not reexamined nor taken into consideration during subsequent performance assessment tasks. In contrast, the proposed disclosure takes advantage of the available behavioral data in learner-produced artifacts and prior performance assessment activities, where they can be used cumulatively or selectively to validate identity and authorship claims of subsequent artifacts produced by the learner, as well as to create models of learner behavior.

The novel approach includes, in part, concurrently validating authorship and identity claims of the learner, through attribution of behavioral patterns from the produced artifacts to that in the student profile. It establishes a unified measure of learner identity and authorship veracity expressed as a confidence level of knowing that the work the learners claim credit for, is actually the work they have done. In contrast, the traditional methods for the provision of academic integrity, conduct identity and authorship validation in a serial fashion, where authentication events aimed at verifying learner identity precede data collection aimed at disproving authorship claims.

Embodiments will be described below while referencing the accompanying figures. The accompanying figures are merely examples and are not intended to limit the scope of the present disclosure. Some of the descriptions contain examples that are intended to be illustrative and do not limit the scope of this invention.

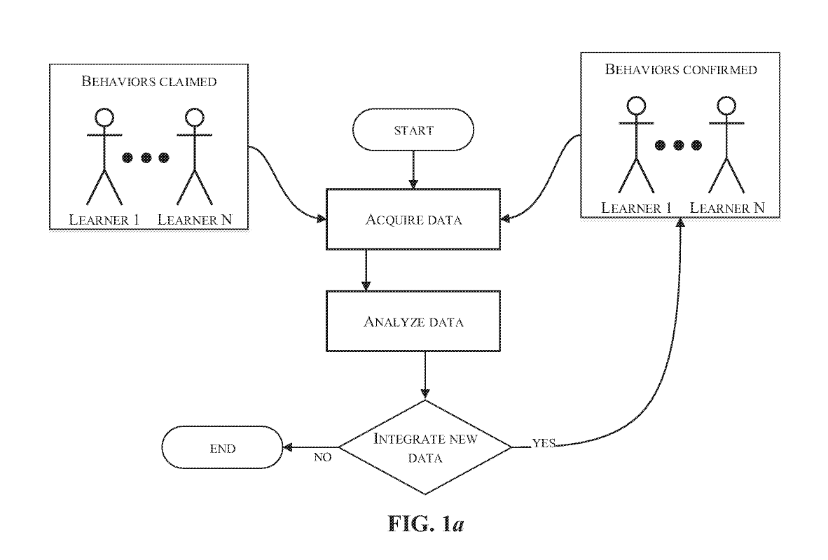

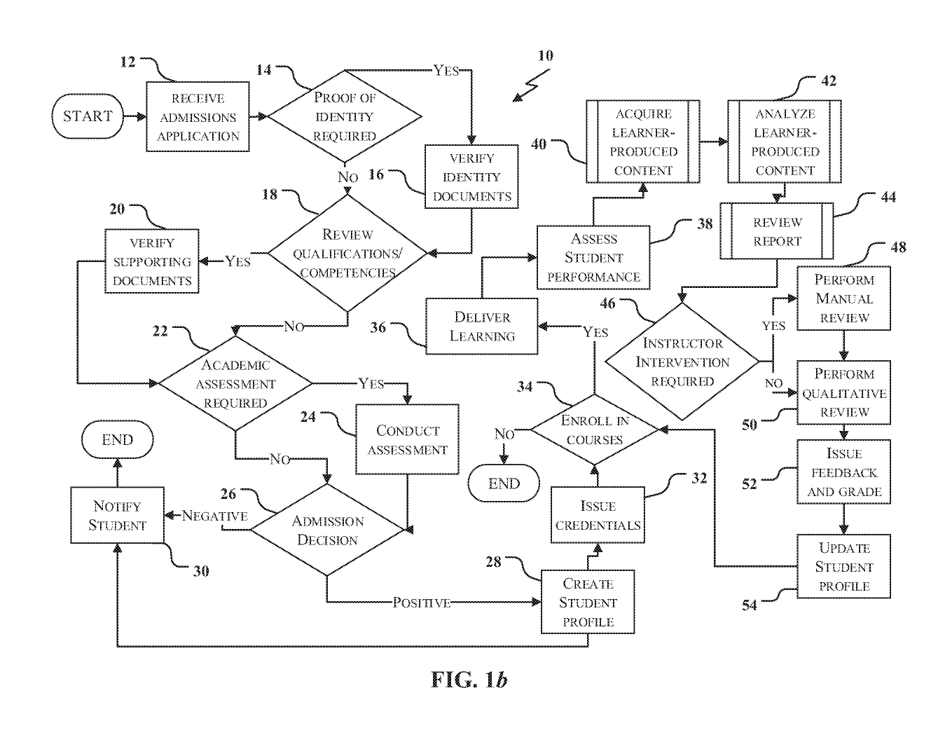

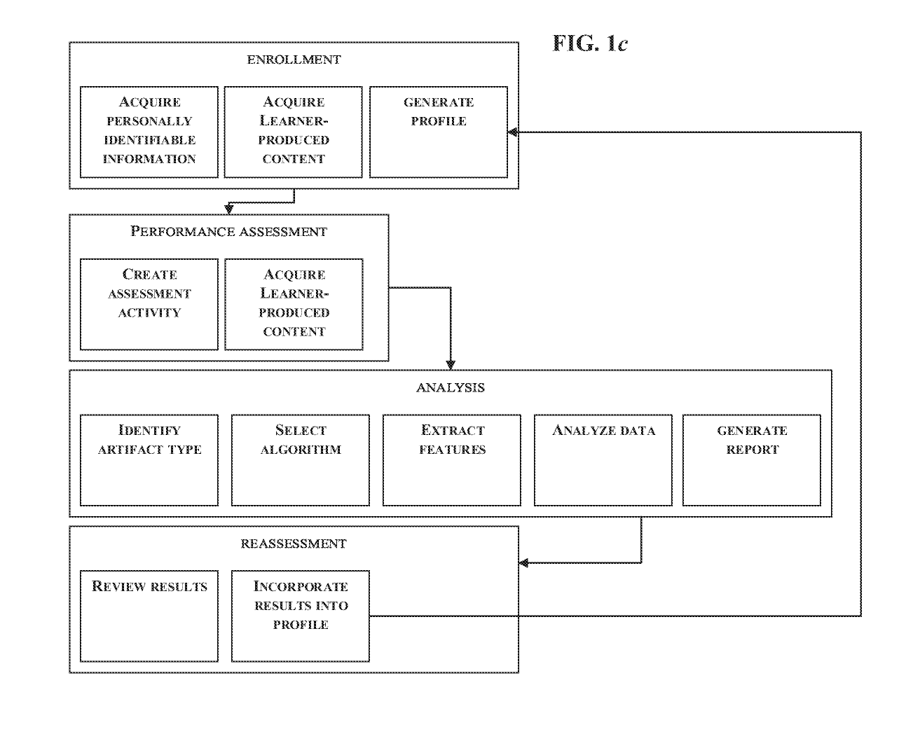

With reference to FIG. 1a, in an embodiment a method for maintaining academic integrity in the learning environment based on analysis of behavioral patterns in learner-produced artifacts is comprised of the following steps: acquiring learner behavioral data; analyzing the acquired behavioral data; and continuously and/or selectively integrating new behavioral data into the subsequent analyses; wherein the behavioral patterns in learner-produced artifacts are compared to the known, previously acquired data and/or modeled behavioral data in order to continuously and/or on-demand estimate the probability of learner identity and the veracity of authorship of the academic work.

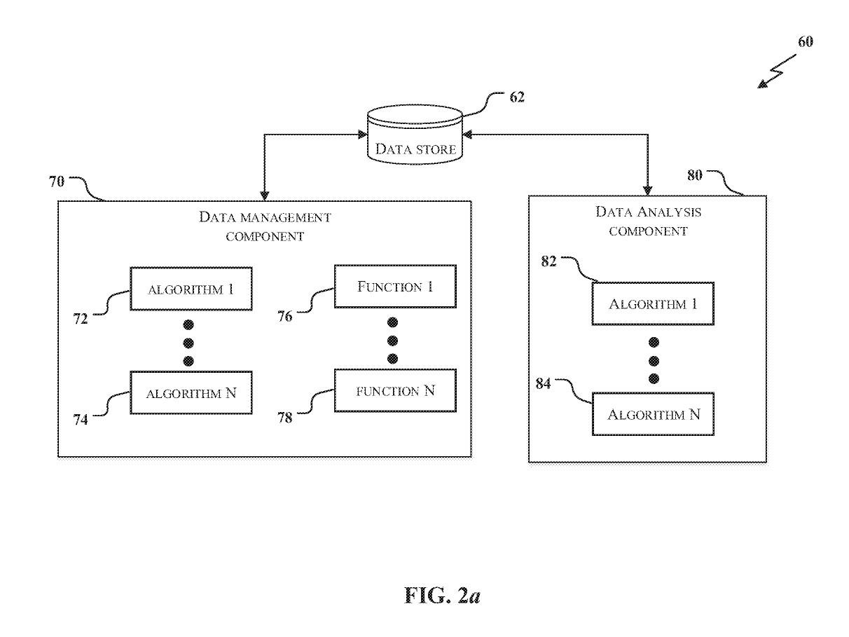

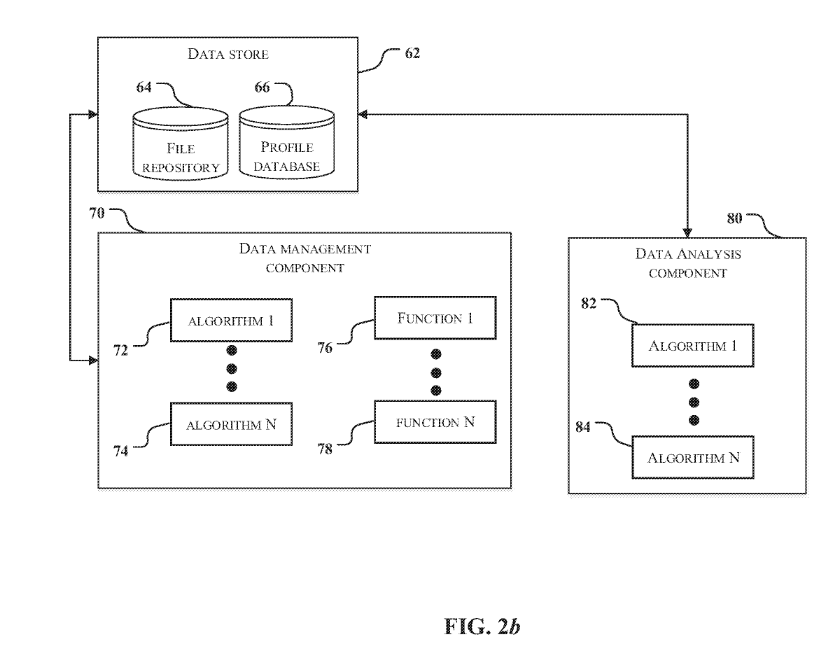

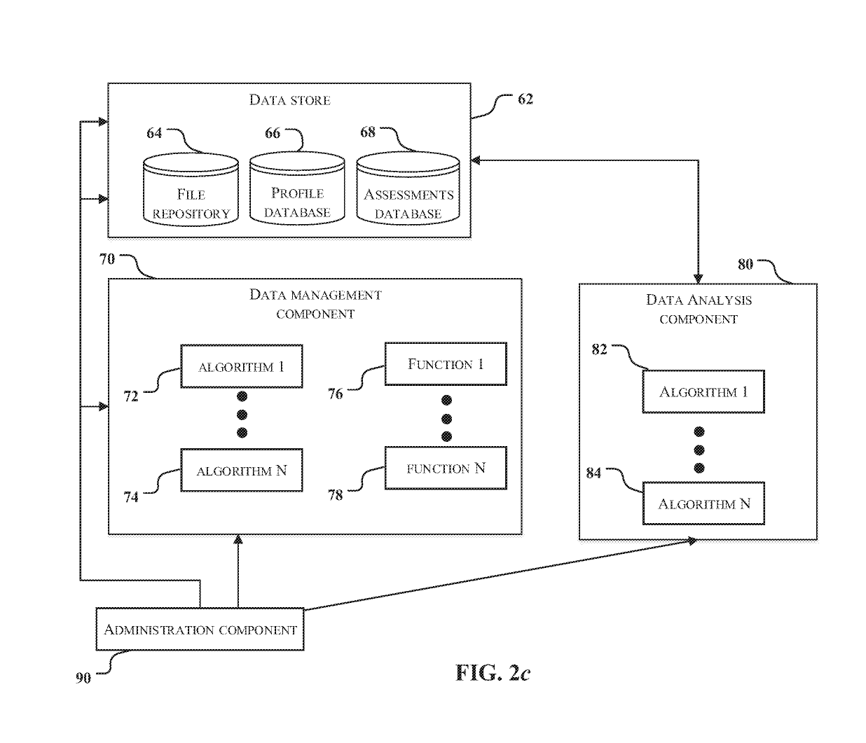

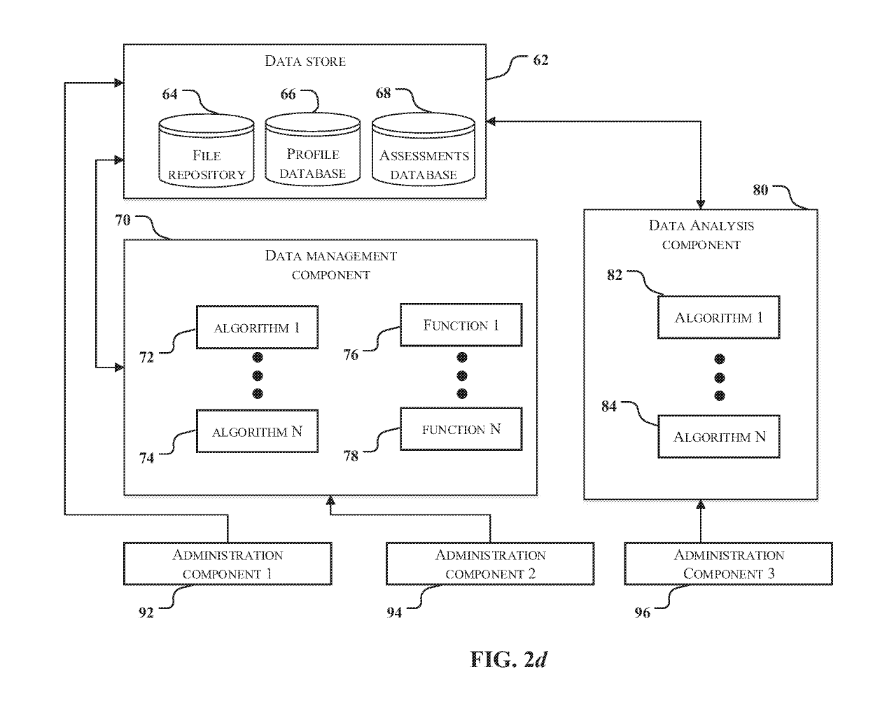

With reference to FIGS. 1b and 2a, in an embodiment a learning process commences with a registration and enrollment phase comprised of one or more of the following: admissions application 12; identity proofing 16; assessment of credentials 20; and entrance examination 24. A decision is made on whether or not the proofing of an identity is required 14 and when it is required the prospective student is requested to provide a proof of identity 16. When a review of qualifications and competencies 18 such as transcripts, standardized test scores, and reference letters is required, the learner is requested to provide these documents 20. Some courses or programs have entrance requirements 22 which entail an assessment of a student's competencies skills and abilities by conducting an examination or evaluation of student's prior academic work 24. Upon successfully meeting the admissions criteria, students are registered, issued a student number, and a profile 28, is created. The profile comprises the data from at least one of the identity verification activities 16, credential review activities 20, and learner assessment activities 24, where behavioral patterns are extracted from learner-produced artifacts using a data analysis component and/or a data management component FIG. 2a (70,80) are mapped to personally identifiable information including official documents and also mapped to the prior qualifications and performance assessment such as the grade point average (GPA) score and the results of internally developed and/or commercially available standardized achievement tests. The quality of identity and authorship assurance is contingent upon the quality of data collection in steps 16,20,24. When self-registration is employed or identity proofing was conducted in a non-controlled fashion, the level of identity assurance in low.

To access academic resources and services, learners are issued a set of credentials 32 such as a student number, student card, username and password for e-mail and academic resources, and/or a library card to be used as a representation of identity and institutional membership. To enhance security and confidence of the subsequent identity verification, an institution may employ additional authentication factors such as what one is, and conduct biometric enrollment, or in a simpler form, take a photograph of the learner to be printed on the student card or the transcripts. A student's profile 28 comprises all student related information as well as its extrapolated form such as behavioral patterns extracted from learner-produced artifacts and analyses and projections of the future performance based on the results of the internally developed and/or commercially available achievement tests. This completes the registration process and students proceed to course enrollment 34. Faculty and staff deliver the course 36.

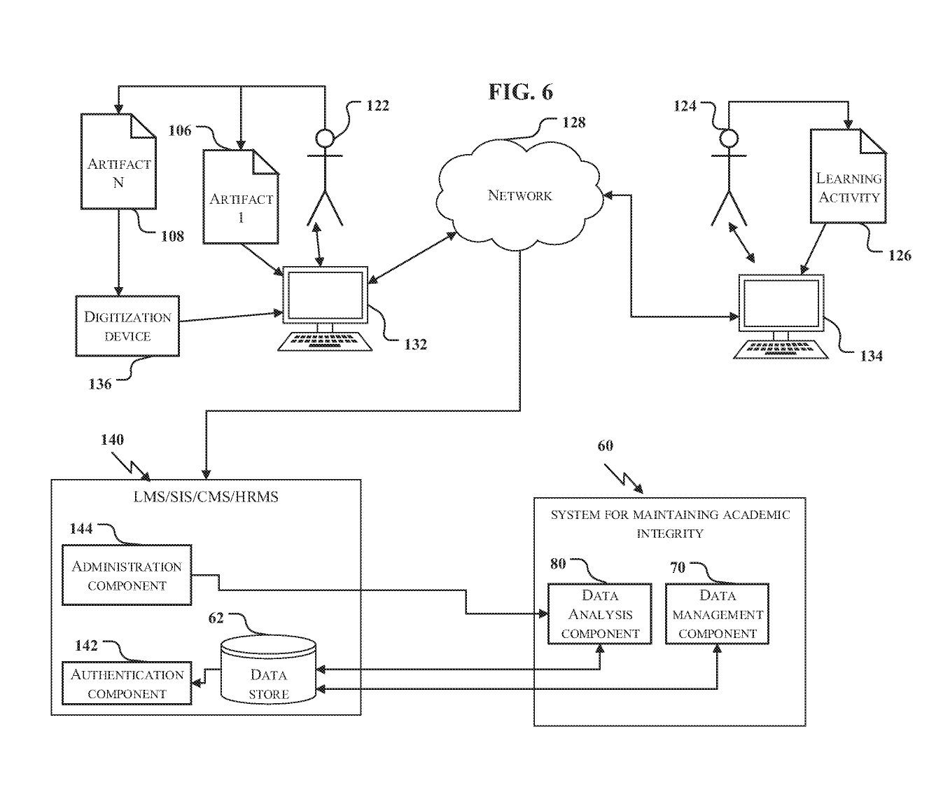

Students participate in learning and assessment activities 38 and produce academic content. The type and format of the content are subject and skill specific and may include any combination of the following: textual content (e.g., research papers, computer source code, sheet music), visual content (e.g., paintings, drawings, computer graphics, photographs, videos), and/or aural content (e.g, vocal recordings). Some artifacts are originally produced in digital format (e.g. emails, computer graphics), while others are produced using the traditional methods (paintings, hand-written sheet music). The latter needs to undergo digitization using digitization device FIG. 6 (136) if these type of artifacts were analyzed using computer-assisted methods.

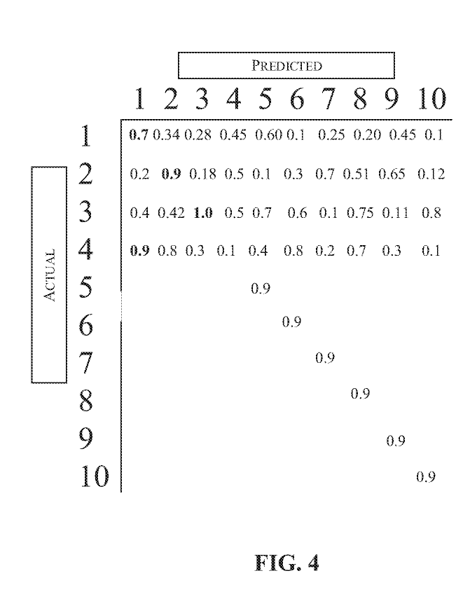

The academic integrity of the learner-produced content is verified by acquiring the learner-produced artifacts 40, and by analyzing the similarity of behavioral patterns within a set and also against the learner profile 42 using the data analysis component FIG. 2a (80). Academic integrity evaluation may be conducted at the end of the course or at the end of each learning activity as instructor deems appropriate. Upon the analysis, a report 44 is generated showing the confidence level FIG. 4 in identity and authorship assurance. The report also flags cases of misattribution, where expected mapping of learner identity to authorship did not occur, and calls for an instructor to intervene and conduct a review of learner-produced work 48. Additional assignments, examinations or activities may be provided to learners whose artifacts were misattributed to other learners. Academic work undergoes qualitative assessment and grading 50, 52. The student's profile is updated 54 to include new data from artifacts or in cases of academic misconduct to reflect just that.

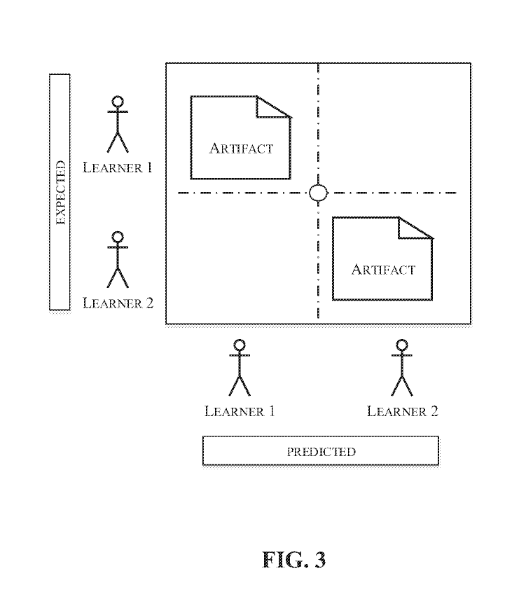

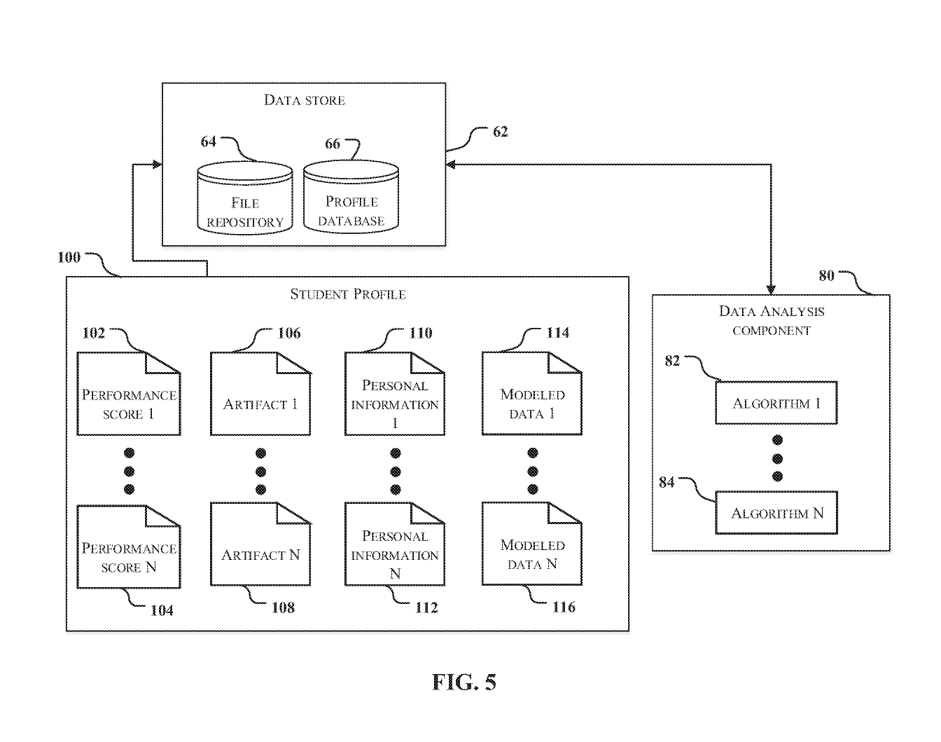

With reference to FIG. 1c, in an embodiment during the enrollment phase, a learner's personally identifiable information and learner-produced content are acquired and a profile that amalgamates the two is created FIG. 5 (100). During the performance assessment phase, learners produce learning activities which are collected for analysis. During the analysis phase, the type of artifact is first identified as algorithmic processing of an artifact is domain specific (e.g., art and literature use different feature extraction and computation methods), an appropriate algorithm is selected, the features are extracted and the data are analyzed where the comparison is conducted to the previously created data in the learner profile as well as to other learner-produced artifacts across the works of the same or different learners. The report is generated showing the confidence level that the learner claiming to have produced the artifact is the same learner who actually have produced the artifact FIG. 3. Any instances of misattribution call for instructor intervention. The results and artifacts are reviewed by the instructor during the reassessment phase and the behavioral data extracted from the artifacts can be selectively incorporated into the learners' profiles.

With reference to FIGS. 2a, 2b, 2c and 2d in an embodiment, a computer-implemented system for maintaining academic integrity in the learning environment based on analysis of behavioral patterns in learner-produced artifacts, comprises of a data management component 70 and a data analysis component 80 connected to a data store 62.

In one embodiment, the data management component 70 is responsible for managing all types of data and data structures. It comprises of an algorithm 72 or multiple algorithms 74 for automating data management (e.g., retrieval tasks, split files into chunks, file format conversion, etc.) and/or functions 76,78 for managing data specific to the data store type implemented (e.g., sorting, copying, deleting, appending, etc.).

### Data Analysis

In one embodiment, the data analysis component 80 utilizes an algorithm 82 or multiple algorithms 84 for processing raw data (e.g. noise removal, standardize encoding, etc.); extracting features or behavioral patterns; storing the processed data in the data store 62; analyzing data using statistical and/or machine-learning techniques, and reporting the results (e.g., storing in a database, emailing, posting to social media, etc.). Parameter tuning algorithms and ensemble algorithms may also be employed to increase performance. One skilled in the art can use any type of algorithms suitable for data processing and computation.

In one embodiment, the data management component 70 includes at least one algorithm for processing raw data (e.g., noise removal, standardize encoding, etc.).

In one embodiment, the data analysis component 80 includes at least one algorithm for automating data management (e.g., retrieval tasks, split files into chunks, file format conversion, etc.).

The type of an algorithm employed for data retrieval, processing and computation would depend on the type of data store employed, and the nature of the data (e.g., text files, video files, audio files). For example retrieval of email messages from a remote mail server requires a different set of procedures than that from stored locally. By the same token, analysis of visual art would employ a different feature set (e.g., color pattern, texture, etc.) than that employed for authorship attribution problem of literary works (e.g., lexical, syntactic, etc.).

In one embodiment, a competence level of a particular skill is used for discriminating content and its producers. In another embodiment, a range of cognitive abilities and impairments serve as discriminators. In another embodiment, patterns of natural language use, serve as discriminators.

In one embodiment, a vector space model is employed. Students complete the work and submit the assignments. Feature vectors from student-produced artifacts are compiled and compared using any of the standard techniques. New artifacts are compared to the related ones in a student's profile and ranked according to similarity. The instructor reviews cases flagged as possible academic misconduct. Subsequent academic work is compared against artifacts in the student's profile.

In another embodiment, a probabilistic model is employed. Students complete the work and submit the assignments. Feature vectors from student-produced artifacts are compiled and compared using any of the standard techniques. New artifacts are compared to the related ones in student profile and ranked according to similarity. The instructor reviews cases flagged as possible academic misconduct and marks them as relevant or irrelevant. The instructor runs a new analysis. Subsequent academic work is compared against the updated student profile that includes artifacts from the previous assignments.

In one embodiment, in addition to using mature supervised machine-learning algorithms (e.g., support vector machine, multi-layer perceptron, etc.), statistical techniques (e.g. Mahalanobis distance, compression models, etc.) can also be applied to compute the distance between vectors.

In another embodiment, unsupervised machine-learning techniques (e.g., nearest neighbors) can be used for learner identification, where the classifier organizes artifacts into clusters sharing an author. Because all artifacts are labeled (each class is the author), any set of artifacts whose labels are not homogeneous is flagged for manual review.

In one embodiment, content level analyses can be conducted (e.g., using Smith-Waterman algorithm, Mixture models, etc.) to detect collusion and plagiarism across learner-produced artifacts in the data store 62.

In another embodiment, content-level analyses of learner-produced artifacts and analyses of qualifications data in a student's profile can be conducted using standard machine-learning or statistical modeling techniques to predict a learner's future performance, on-demand and/or continuously.

There are several advantages of the described approach. The main one is the interchangeability of algorithms and data analysis techniques. As computer science advances, new forms of media become available, as do the approaches to data retrieval, processing and computation. They can augment the old approaches or replace them. Analyses can be customized to each assessment task, allowing the authorship verification problem to be posed as an open set or a closed set problem.

### Data Store

With reference to FIG. 2c, 2d, the data store component 62, is a repository for storing data and may include at least one of various types of storage including relational and non-relational databases, file storage, email containers, simple text files, etc. The data store can be comprised of multiple data repositories or of a single database 64, 66, 68.

In one embodiment, data store 62 or its components can be a part of another system (e.g., learning management (LMS), content management (CMS), or human resource management (HRMS), student information system (SIS), etc.).

In another embodiment, data store or its components can be a part of a computer-implemented system for maintaining academic integrity in the learning environment based on analysis of behavioral patterns in learner-produced artifacts 60.

### System Configuration

With reference to FIG. 2c, in an embodiment, components 62, 70, 80 can be configured using a single administration component 90.

With reference to FIG. 2d, in an embodiment, configuration and administration of the components 62, 70, 80 can be conducted using multiple administration components 92, 94, 96.

With reference to FIGS. 2c and 2d, in another embodiment, each data storage component 64, 66, 68 and algorithm(s) 72, 74, 82, 84 can be configured both internally and have a configuration interface 90, 92, 94, 96.

In another embodiment, any combination of the above configuration variations can exist.

### Reporting

In one embodiment, the reporting function can be integrated into an algorithm 82 or created as a separate algorithm 84 whose role is to communicate the results of the analysis. The analysis results can be presented in various forms and formats. For example the results can be stored in a component of the data store 62, they can be e-mailed, they can be sent via text message or posted on social media. The results can also be presented in a variety of formats ranging from text to multimedia formats.

In one embodiment, the report may contain only the basic information such as a list of learners whose work requires manual review. In another embodiment, it may provide a highly detailed analysis report, depicting one or more of the following: predicted probabilities of the behavioral pattern attribution, learners' academic abilities, future performance a predefined set of behaviors, absolute or relative frequencies of behavioral markers.

With reference to FIGS. 2c and 5, in an embodiment the instructor creates a list of assessment tasks using the administration component 90 which creates corresponding data structures in the assessment database 68. The academic administrator or the instructor creates a student profile by uploading samples of learner-produced academic work 106, 108 into the file store 62 and enters the academic performance scores (e.g., GPA, standardized test scores) 102, 104 into the profile database 66. The academic administrator or the instructor runs the analysis of the learner-produced academic artifacts using algorithms in the data analysis component 80, which extracts behavioral features from learner-produced artifacts and store them in the student profile database 66. Learners complete assessment activities and upload their academic work to file repository 64 using a function 78 of the data management component 70. Algorithm or multiple algorithms 84 automatically analyze the learner-produced artifacts and e-mails the results to the instructor, who conducts a manual review of artifacts whose expected and predicted labels do not match FIG. 3.

In another embodiment, the data analysis component 80 can utilize algorithms 82,84 that extrapolate student data 102,104,106,108,110,112 to create a model of learner's behavior 114, 116 that becomes a part of the student's profile 100 stored in one of the components of the data store 62 and is used for prediction of future performance, and/or for the provision of identity and authorship assurance in learner-produced artifacts.

With reference to FIG. 6, in an embodiment, the computer-implemented system for maintaining academic integrity in the learning environment based on analysis of behavioral patterns in learner-produced artifacts 60 comprises the data analysis component 80 and the data management component 70 integrated with the learning management system (LMS) 140. One skilled in the art can use any system capable of content dissemination and collection (e.g., content management system (CMS), or human resource management (HRMS), etc.) as an alternative to the LMS 140.

In one embodiment, an application programming interface (API) provides an interface for functions to interface between the LMS 140 and the computer-implemented system for maintaining academic integrity in the learning environment based on analysis of behavioral patterns in learner-produced artifacts 60.

In one embodiment, the administration component 144 can manage all components of the LMS 140 (e.g., add/delete users, post/delete learning tasks, etc.) as well as that of the system 60 (e.g., select algorithms, analyze content, etc.).

In one embodiment, system 60 may use the authentication component 142 of the LMS 140 to verify user credentials and grant privileges to a role for access.

In some embodiments, an authentication component 142 is not required and may be omitted. Artifacts 106 and 108 can be manually labeled by the instructor using the data management component 70.

In one embodiment, attribution or classification of behavioral patterns extracted from learner-produced artifacts 106 and 108 to those in the student's profile 100 using the data analysis component 80 is considered a reporting task and is independent of the identity verification processes employed by the LMS 140.

In one embodiment, the data management component 70 is responsible for acquiring learner-produced content from the data store 62.

In one embodiment, the authentication component 142 is used for identity verification of learners submitting the academic work, passing on the identity label to the data management component 70 that is used to receive and store learner-produced content, attaching a label identifying the learner making the submission and creating the necessary data structure in the data store 62 for storing raw data and/or behavioral data extracted from the artifacts by an algorithm of the data management component 70 or an algorithm of the data analysis component 80.

In one embodiment, the instructor 124 is posting a learning activity 126 by using a computer 124 connected to the LMS 140 and its administration component 144 through a network 128. The learner 122, accesses LMS 140 by using a computing device 132 connected to the network 128 and is able to view the posted learning activity 126. Both the learner and the instructor authenticate to the LMS 140 by using its internal authentication component 142. The learner 122 participates in the learning activity 126 which results in the production of an artifact 106 which was created using a computing device 132.

In another embodiment, the learner 122 may produce an artifact 108 by the non-computerized means and to make the artifact 108 transferrable through the network, the learner 122 uses a digitization device 136 (e.g., digital camera, scanner, digital audio recorder, etc.) which converts the non-digital items to a digital form which is then transferred over the network 128 to LMS 140, using a computing device 132.

In one embodiment, the artifacts 106 and the digital representation of the artifact 108 and their extracted behavioral features are stored in the data store 62.

In one embodiment, the learner 122 can view, modify, replace and delete the artifacts stored in the data store 62 using the data management component 70.

In another embodiment, the learner 122 submits artifacts to the instructor 124 via an email or via other medium that does not allow modification of the submitted content. The instructor 124 can view, modify, replace, and delete the artifacts stored in the data store 62 using the data management component 70 and conduct analyses using the data analysis component 80.

In one embodiment, the instructor 124 can view, modify, replace, delete the artifacts stored in the data store 62 using the data management component 70 and also analyze them using the data analysis component 80.

In one embodiment, a course may be comprised of at least one learning activity 126, where behavioral features extracted from artifacts produced during each activity are analyzing within a set of artifacts submitted by learners within the same academic unit (e.g., course, program, year). In another embodiment, the analysis is performed using artifacts submitted by learners within a select set of academic units (e.g., course, program, year).

In one embodiment, a course may be comprised of at least one learning activity 126, where behavioral features extracted from artifacts, using the data analysis component 80, produced during each activity are compared, using the data analysis component 80, against a student's profile data in the profile database FIG. 5 (66), which is updated to include new behavioral data after each subsequent activity.

In one embodiment, the instructor 124 may specify using the administration component 144, which learning activity or activities 126 should undergo the identity and authorship assurance analysis using the administration component 144.

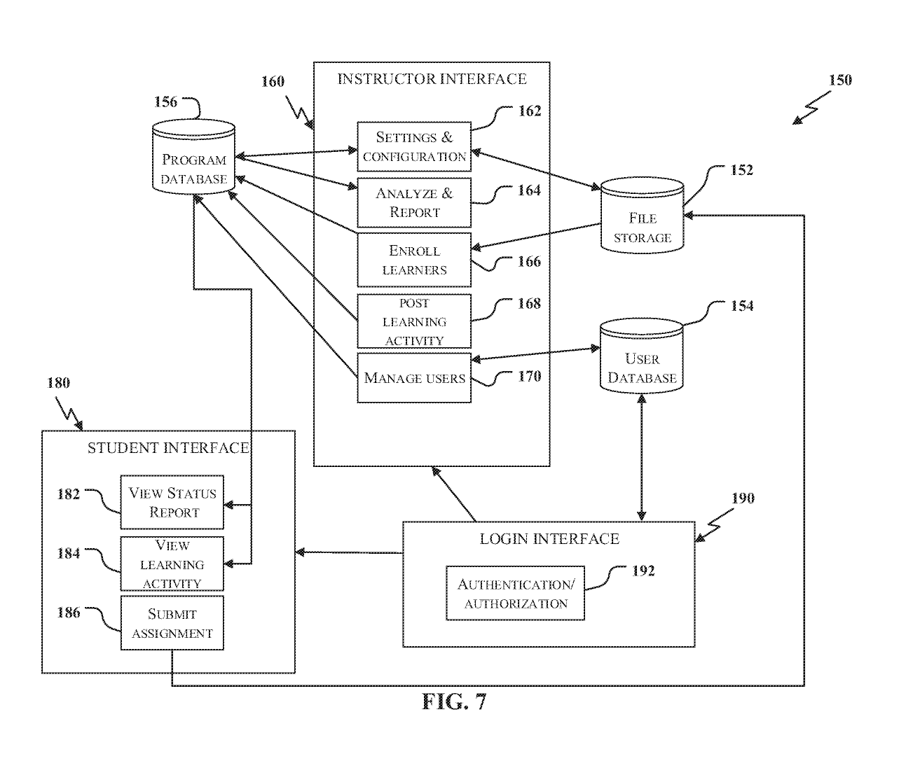

With reference to FIG. 7 in an embodiment, a system for maintaining academic integrity in the learning environment based on analysis of behavioral patterns in learner-produced artifacts comprises the authentication/authorization interface 190, instructor interface 160, student interface 180 and data store is comprised of three components including: the user database 154, the file storage 152 and the program database 156. One skilled in the art can use any type and number of databases or data storage types as well as any kind of authentication techniques.

The instructor interface 160 is comprised of the following components: settings and configuration 162, analyze and report 164, enroll learners 166, post learning activity 168, manage users 170. The student interface 180 is comprised of three components and includes: the view status report component 182, the view learning activity component 184 and the submit assignment component 186.

In one embodiment, the instructor configures the system 150 by using the settings and the configuration component 162 to specify at least one of the parameters to control or manage other system components. For example, configuration may include: specifying the type of algorithm and procedural steps in the data analysis component 80; the data type, file size limitations, storage types in the data store 62 and its components. One skilled in the art can make the configuration component 162 to control as many aspects of the system 150 as one desires, or to the contrary limit the ability of a certain user group to access certain configuration parameters and features.

In one embodiment, the instructor may use the enroll learners component 166 to provide learner-generated content to the computer-implemented system for maintaining academic integrity in the learning environment based on analysis of behavioral patterns in learner-produced artifacts 150, to be used as training data for supervised classification algorithms. One skilled in the art can use any type of algorithms available including those that do not require training, and omit or disable the enroll learners component 166 completely or only for certain tasks.

In one embodiment, the instructor may specify which learning activities require identity and authorship assurance through the post learning activity component 168. Learner-generated content from the specified learning activities can be automatically acquired or learners may be required to manually upload the artifacts using the submit assignment component 186. Learners can also view the list of learning activities that are marked for analysis using the view learning activity component 184. When learners are uploading their artifacts using the submit assignment component 186, they select the appropriate learning FIG. 6 (126) activity from the list of available learning activities. Upon analysis or evaluation, learners may view the assessment report using the status report 182.

In one embodiment, the status report 182 is not available to learners.

In another embodiment, the type of the report generated for the learner 182 and the report generated for the instructor 164 and the method of the report dissemination is configurable through the settings and configuration component 162. One skilled in the art can use any format and any means for presenting the results of the analysis.

In one embodiment, learners may be allowed to delete, replace, edit or modify any uploaded artifacts. In another embodiment, the revision of the submitted work is not allowed. And in some embodiments, revision of the artifacts cannot be performed after the analysis has been performed. These variations of what and how students can modify the artifacts once they have been submitted using the submit assignment component 186 can be configured using the settings and the configuration component 162.

In one embodiment, the instructor can manage users using the manage users component 170 connected to the user database 154. In another embodiment, the manage users component 170 can be connected to the user database of another system. In one embodiment, the user management function could be a part of a different system such as the LMS 140. One skilled in the art can use any type of authentication system of any design and/or replace the manage users component 170 and the login interface 190 by that of another system if necessary.

In one embodiment, the instructor is using the analyze and report component 164 to classify learner-produced artifacts against those uploaded using the enroll learners component 166. In another embodiment, the instructor is clustering the learner-produced artifacts.

In one embodiment, the analysis of the learner-produced artifacts can be conducted automatically, upon a student completing the learning activity or scheduled to run at a certain time.

In another embodiment, the analysis of the learner-produced artifacts is conducted manually, after each learning activity or at the end of the course as instructor deems appropriate.

While several illustrative embodiments of the invention have been shown and described, numerous variations and alternative embodiments will occur to those skilled in the art. Such variations and alternative embodiments are contemplated, and can be made without departing from the scope of the invention as defined in the appended claims.

1. A system for maintaining academic integrity in the learning environment, based on analysis of behavioral patterns in learner-produced artifacts comprising:
a data management component for retrieving and processing data,
a data analysis component for analyzing data, and a data storage component for storing raw and processed data;
wherein the behavioral patterns in learner-produced artifacts are compared to the known, previously acquired data and/or modeled behavioral data in order to continuously and/or on-demand estimate the probability of learner identity and the veracity of authorship of the academic work.

2. The system according to claim 1, wherein prediction, attribution or classification accuracy is established to a degree of probability by the analysis component.

3. The system according to claim 1, wherein the type and format of the learner-produced content includes at least one of the following: textual content including research papers, computer source code, sheet music; visual content including paintings, drawings, computer graphics, photographs, videos; and aural content including vocal recordings, and instrument recordings.

4. The system according to claim 1, wherein behavioral data include one or more of the following: authorial style, natural language use, computer language use, color palette preferences, drawing techniques, speech patterns, vocal range, timbre, breathing idiosyncrasies, articulation, genre preferences, repertoire, gait, gesture idiosyncrasies, handwriting idiosyncrasies, finger movements, lips movements, and eye movements, competence level, range of cognitive abilities and impairments.

5. The system according to claim 1, wherein one or more of its components are integrated with another system.

6. The system according to claim 1, wherein misattribution or multiple attribution of the behavioral patterns during the analysis step call for instructor intervention.

7. The system according to claim 1, wherein incongruence of competence level between the student profile and the learning activity during the analysis step call for instructor intervention.

8. The system according to claim 1, wherein identity and authorship assurance of the learner-produced artifact is attained through comparison of behavioral patterns in learner-produced content created in the course of learning to that in the student profile.

9. The system according to claim 1, wherein a student profile is comprised of one or more of the following : personally identifiable information, academic artifacts, behavioral data extracted from academic artifacts, modeled behavioral data, academic performance, standardized test results.

10. The system according to claim 1, wherein student profile is continuously, on-demand or selectively updated to include one or more of the new behavioral data extracted from each subsequent production of academic artifact, personally identifiable information, modeled behavioral data, academic performance, or standardized test results.

11. A method for maintaining academic integrity in the learning environment, based on analysis of behavioral patterns in learner-produced artifacts comprising the steps of:
acquiring learner behavioral data, analyzing the acquired behavioral data, and continuously and/or selectively integrating new behavioral data into the subsequent analyses;
wherein behavioral patterns in learner-produced artifacts are compared to the known, previously acquired data and/or modeled behavioral data in order to continuously and/or on-demand estimate the probability of learner identity and the veracity of authorship of the academic work.

12. The method according to claim 11, wherein incongruence of competence level between the student profile and the learning activity during the analysis step call for instructor intervention.

13. The method according to claim 11, wherein identity and authorship assurance of the learner-produced artifact is performed through comparison of behavioral patterns in learner-produced content created in the course of learning to that in the student profile.

14. The method according to claim 11, wherein student profile is continuously, on-demand or selectively updated to include new behavioral data extracted from each subsequent production of academic artifact.

15. The method according to claim 11, wherein prediction, attribution or classification accuracy of the analysis component is established to a degree of probability.

16. The method according to claim 11, wherein the type and format of the learner-produced content includes at least one of the following: textual content including research papers, computer source code, sheet music; visual content including paintings, drawings, computer graphics, photographs, videos; and aural content including vocal recordings, and instrument recordings.

17. A non-transitory computer-readable medium storing a set of programmable instructions configured for execution by at least one processor for maintaining academic integrity in the learning environment, based on analysis of behavioral patterns in learner-produced artifacts, the method comprising the steps of: acquiring learner behavioral data, analyzing the acquired behavioral data, and continuously and/or selectively integrating new behavioral data into the subsequent analyses;
wherein the behavioral patterns in learner-produced artifacts are compared to the known, previously acquired data and/or modeled behavioral data in order to continuously and/or on-demand estimate the probability of learner identity and the veracity of authorship of the academic work.

18. The non-transitory computer readable medium according to claim 17, wherein the learner can perform one or more of the following: create content, share content, modify content, or upload content, view academic activities, or status reports.
